(19) United States
(12) Patent Application Publication
(10) Pub. No.: US 2025/0175360 A1
(43) Pub. Date: May 29, 2025

(54) SYSTEM AND METHOD OF MANAGING COMMUNICATION INTERACTIONS

(71) Applicant: SPITCH TECHNOLOGY LTD, Shoham (IL)

(72) Inventors: Nadav BARIAH, Shoham (IL); Guy KEDEM, Ramat Hasharon (IL)

(21) Appl. No.: 18/841,588

(22) PCT Filed: Mar. 6, 2023
(86) PCT No.: PCT/IL2023/050227

§ 371 Date: Aug. 26, 2024

(30) Foreign Application Priority Data
Mar. 6, 2022 (IL) 291147

(51) Int. Cl. H04L 12/18; H04N 7/15

(52) U.S. Cl. CPC H04L 12/1822; H04N 7/15

(57) ABSTRACT

Some embodiments are directed toward a communication system including a server configured to link between computer devices and communicate with a repository comprising a plurality of session datasets associated with a respective plurality of session-plans. The conductor and participant interfaces can be configured for use by data/content communication applications executed in their respective computer devices for conducting an interpersonal communication session therebetween. A session module configured in the conductor and/or participant interface can guide the interpersonal communication session to follow a protocol defined by a session-plan selected from the plurality of session-plans and facilitate selection of information and/or content items from the respective session dataset associated with the selected session-plan for display in the participant interface.

### CROSS-REFERENCE TO RELATED APPLICATIONS

This application is a national phase filing under 35 C.F.R. § 371 of and claims priority to PCT Patent Application No. PCT/IL2023/050227, filed on Mar. 6, 2023, which claims the priority benefit under 35 U.S.C. § 119 of Israeli Patent Application No. 291147, filed on Mar. 6, 2022, the content of which is hereby incorporated in its entirety by reference.

### TECHNOLOGICAL FIELD

The presently disclosed subject matter is generally in the field of interpersonal data communication, particularly useful for one-to-one, one-to-many, many-to-one or many-to-many interpersonal real-time digital interactions.

### BACKGROUND

This section intends to provide background information concerning the present application, which is not necessarily prior art.

A plethora of digital communication tools are available nowadays for online data exchange in real-time between users utilizing computerized devices e.g., personal computers-PCs, laptops, smart devices (e.g., telephones, tablets, watches, personal digital assistance-PDA, and suchlike). These digital communication tools enable users to exchange and share online almost all types of digital content e.g., text files, image files, presentation files, video files, audio files, software files, over landline (e.g., wire, optical and/or cable) and/or wireless (e.g., wireless telephony, WiFi, Bluetooth, etc.) data/telephony communication network infrastructures (e.g., the Internet).

The use of video call applications e.g., SKYPE, ZOOM, MS-TEAMS, GOOGLE-MEET, has been steadily growing in the past years, and since the eruption of the COVID-19 pandemic are widely used to replace regular interpersonal communication interactions e.g., work meetings, school teaching, lecturing, training, treatment session, by conducting inter alia video conference calls and/or remote teaching/lecturing sessions for remote participants e.g., of webinars, workers working from home, e-commerce customers, or suchlike, due to the social/physical distancing requirements the pandemic dictated. The advantages of these video call applications in terms of efficiency and time and resources savings are indeed being now recognized, and it is anticipated that their use will be continued and further increased for meetings, teaching/lecturing, training and/or treatment provision, and other such interpersonal communication interactions, long after the coronavirus pandemic will end.

Video call applications are regularly used for other purposes as well, such as, for example, gaming, journalism, online interviews, medical treatment etc. There is now also an increasing interest in developing and promoting video commerce applications, wherein live and/or non-live video content is used to promote and sell products/services to remote customers. Video commerce enables retailers to present and demonstrate features of their products/services in a detailed and entertaining fashion, and provide the customers a new shopping experience, as they can remotely study products/services of interest without physically visiting the stores/marketplaces, exploiting all recent technological advancements and yet enjoy a human/interpersonal interaction experience.

Video films are easy to share and can quickly convey significant amounts of information to the potential consumers, compared to reading product specifications and viewing still images thereof, while allowing sympathetic interactions in a technologically distant/impersonal environment. Video content is substantially easy and inexpensive to produce and edit by average users utilizing cameras of smart devices and free readily available video editing software products. Live e-commerce video streaming enables the presenters (also termed herein conductors) to understand in real time how their audience (also termed herein participants) is reacting to the presented product/service, and directly address their questions and needs on-line. It is appreciated that e-commerce videos increase customers participation time and their propensity to convert.

However, for the most part, the use of video streaming applications/platforms merely harnesses the existing video streaming applications/platforms to add and present (usually) non-live video content to participants, and/or provide a live video experience. In e-commerce for instance, non-live video content is being added now in many e-commerce platforms (e.g., e-commerce websites) for presenting products/services to potential customers. Clearly, the simple addition of non-live video content can provide a limited experience to the potential customers for the lack of customer-seller interaction. On the other hand, the use of video call applications for live streaming e-commerce content requires that both parties install and run a dedicated video call application.

Video commerce solutions known from the patent literature are briefly described hereinbelow.

Vehicle sales management and video chat systems and methods are disclosed in US Patent Publication No. 2020/137353, which utilize website listings that correspond to vehicles for sale at a dealership. A remote visitor clicks a “live video” button beside a desired vehicle, and schedules a time for a video chat, using their web browser. A dealership salesperson receives an alert, via a sales application running on the salesperson's mobile device. At the scheduled time, a video chat window opens in the visitor's web browser with live audio/video of the desired vehicle from the dealership in real-time. The website visitor uses their web browser for live communication, in real-time, to the salesperson on their sales application. After the video chat, the website visitor can use their browser to download and save a recording of the video chat session.

A sales administration system that manages online sales via overlays on a video stream is disclosed in US Patent Publication No. 2021/084361. Customers can comment on or respond to the video stream, and may order products using simple phrases such as “Sold”. The system can stream video with overlays to multiple clients simultaneously, including websites and mobile apps. Comments from all clients are received, aggregated, processed for orders, and displayed to the sales administrator. The system is coupled to a merchant's operational data, providing immediate visibility to changes in inventory and orders. Video overlays may be updated automatically by the system as this operational data changes, for example highlighting products with low stock. The system may analyze customer comments and orders both during the video stream and after the sales session is complete, and may generate recommendations to improve sales effectiveness. For backorders, customers may preauthorize charges to be at the front of the queue for shipment.

### General Description

The present disclosure provides techniques, interfaces, systems and methods, for managing interpersonal communication sessions between at least one conductor and at least one participant. The interpersonal communication is usually initiated by the conductor, but in possible embodiments it may be initiated by the participant. During a session initiation stage the communicating parties receive and operate respective user interfaces configured to conduct the interpersonal communication session in accordance with a predetermined session plan (e.g., complying with a sales playbook) specifically designed to achieve a certain goal, promote a certain agenda, and/or convey predefined information and/or shareable content items to the participant. For each interpersonal interaction the system may use user interfaces specially designed for the specific interaction of the communication session, which may be for example, but not limited to, a remote online teaching lesson/lecture (e.g., webinar), an online (e.g., journalism, deployment) interview, online game, training, treatment provision, technical (or non-technical) support, technical support, sales meeting, or suchlike.

The term interpersonal communication interaction used herein to refer to online interactions with one or more participants e.g., for conveying information/content, and/or promoting an agenda, and/or achieving a desired goal. The interpersonal communication according to possible embodiments is conducted in accordance with a predefined protocol/methodology designed to achieve a goal and/or interaction process expected by the participating parties.

The initiation stage involves provision of a conductor interface to at least one conductor of the interpersonal communication session, and a participant interface to at least one participant of the communication session. The conductor/participant interfaces can be graphical user interfaces configured for communicating data/content between computer devices and/or controlling an interpersonal communication session conducted between the computer devices of the communicating parties in accordance with a specially designed session plan. Preferably, but need not necessarily, the conductor interface is configured to follow the session plan chosen for the interpersonal communication session, but the participant interface(s) can be similarly configured as well.

The conductor and/or participant interfaces are configured for use by applications capable of data/content communication, preferably, but need not necessarily, over data/computer networks (e.g., the Internet). Optionally, but in some embodiments preferably, the conductor and/or participant interfaces are implemented as web pages comprising graphical user interface (GUI) and program code (e.g., scripts) used by regular web browsers to carry out the interpersonal communication between the communicating parties.

An interpersonal communication session according to possible embodiments can start in provisioning of a conductor interface to one or more conductors (e.g., after authentication thereof), and using the same to send one or more invitations to potential participants to join the interpersonal communication session. The conductor interface can be configured for the selection of a project from a list of predefined projects (e.g., course/class lesson, interview, game, product commerce, personal treatment/training, customer service, etc.) and one or more participants from a list of potential participants for the specific project selected. The conductor interface can be further configured to send (e.g., by email, SMS, or suchlike) the invitations to the selected participant(s) and retrieve a suitable session plan for the selected project and/or relevant interaction process. The session plan is configured to efficiently and effectively convey to the participant(s) one or more information and/or shareable content items in accordance with a defined protocol designed to achieve the goal and/or agenda promotion, serving the relevant process e.g., participants' acquaintanceship in sales meeting.

The invitation sent to the participant(s) is configured to retrieve a participant interface to be used by one or more applications of the participant computer(s) for communicating with the conductor computer(s). Preferably, but need not necessarily, the invitation comprises a network address e.g., URL and/or IP address configured to transmit a request for the participant interface from a remote computer (e.g., web server). After the participant interface is received in the participant computer, it is opened by a suitable data/content communication application for establishing data/content communication with the conductor computer(s). The conductor and participant interfaces can be configured for audio-visual (e.g., video-call/meeting) communication between the communicating parties, and for conveying the information and/or shareable content items selected by the conductor(s) from the step content presented in the conductor interface(s) to the participant(s) interfaces.

Preferably, but need not necessarily, the protocol of the session plan is defined by a plurality of steps, each steps configured to concentrate on one or more topics associated with the selected project. The participant interface is configured to guide the conductor through the various steps of the session plan for managing the interpersonal communication session at least partially in accordance with the protocol designed for the selected project. Optionally, but in some embodiments preferably, each step of the session-plan is associated with a step content comprising a plurality of information and/or shareable content items to be at least partially conveyed to the participant(s) within the step duration. The conductor interface can be accordingly configured to fetch for the conducted step the respective step content, and present the at least some of the information and/or shareable content items of the step content to the conductor(s) for selection and presentation to the participant(s). The session plan can be configured to promote and encourage a dialogue/conversation between the communicating parties concerning the various topics and/or selected information and/or shareable content items of different steps of the session plan.

In one aspect the present application is directed to an interpersonal communication system comprising a server configured to selectively convey conductor and participant interfaces to respective computerized devices and communicate with a repository comprising a plurality of session datasets associated with a respective plurality of session-plans, the conductor and participant interfaces configured for use by data/content communication applications executed in their respective computerized devices for conducting an interpersonal communication session therebetween, and a session module configured in the conductor and/or participant interface to guide said interpersonal communication session to follow a protocol defined by a session-plan selected from said plurality of session-plans and facilitate selection of information and/or content items from the respective session dataset associated with the selected session-plan for display in the participant interface.

In a possible implementation the interpersonal communication system comprises a server configured to convey conductor and participant interfaces to respective computer devices of a conductor and at least one participant, and to communicate with a repository comprising a plurality of session datasets and a plurality of session-plans, each one of the plurality of session-plans comprising a plurality of session steps, each of which being associated with at least one session dataset from the plurality of session datasets, each one of said plurality of session datasets comprising information and/or instructions, and/or content associated with a theme of the session step, the conductor and participant interfaces configured for use by data/content communication applications executed in their respective computer devices and for establishing a video session for interpersonal interaction between the conductor and the at least one participant to interact with each other; and a session module configured in the conductor and/or participant interface to manage the interpersonal communication session for carrying out steps of the plurality of session steps of a session-plan selected from the plurality of session-plans for said interpersonal communication, and to facilitate selection of the information and/or content and/or perform the instructions of at least one of the session datasets associated with each step of the selected session-plan being carried out for the interpersonal interaction between the conductor and the at least one participants.

The server is configured in some embodiments to authenticate the at least one conductor before conveying the conductor and/or participant interface to their computer devices. Optionally, the conductor interface is configured to send to the computer device of the at least one participant instructions to request from the server the participant interface.

Each one of the plurality of session datasets can comprise several sets of guiding data and sharable information/content items, each one of the several sets of guiding data and sharable information/content items being associated with a theme of a respective step and/or sub-step of the session-plan associated with the session dataset. In some embodiments the session plan is configured in a form of a concatenation of the steps and/or sub-steps to be consecutively performed, or in a form of decision tree comprising a plurality of bifurcations and branches at least some of which connected by decision making junctions. A topic navigation component can be used in the conductor and/or participant infaces for selecting one or more predefined topics/sub-step in each one of the steps of the selected session plan.

Each one of the plurality of session plans is configured in some embodiments to convey certain information/content, and/or promote a certain agenda, and/or achieve a certain task, and/or facilitate a certain interaction process, utilizing the content selected for display in the participant interface.

The system comprises in some embodiments a participant analysis module configured to monitor communication from the at least one participant interface and determine a level of participation thereof in the interpersonal communication session. Optionally, the participant analysis module is configured to analyse participant's utterance, verbal intonations, and/or body language gestures. The participant analysis module can be configured to analyse communication from the conductor interface and present corresponding tips and/or recommendations to said at least one conductor. In some embodiments the tips and/or recommendations are associated with time intervals associated with certain steps, and/or sub-steps, and/or information/content items, of the selected session plan.

The system comprises in some embodiments a guidance component in the conductor interface configured to provide guiding information for interaction with the at least one participant. The system can comprise one or more timers configured to measure time durations of interactions between the at least one conductor and the at least one participant in connection with a certain topic, and/or step, and/or sub-step, and/or information/content item, of the selected session-plan. optionally, the system comprises a tips section in the guidance component configured to present to the at least one participant tips at least partially associated with the time durations measured by the one or more timers, and/or information/content of the session dataset used with the selected session plan, and/or step and/or sub-step of the selected session plan.

In some embodiments the system comprises an alerts section in the guidance component configured to issue alerts for the at least one conductor's consideration based at least partially on the determined level of participation of the at least one participant and/or the measured time durations. The system can comprise a comments and/or reminders section in the guidance component configured to present to the at least one participant comments and/or reminders at least partially associated with the information and/or content of the session dataset used with the selected session plan in accordance with the step and/or sub-step of the selected session plan.

The system utilizes in some embodiments an artificial intelligence (AI) module configured to produce insights, and/or identify patterns, and/or discover relationships, based on a plurality of interpersonal communication sessions conducted by the system e.g., by analyzing the conductor's interaction during one or more communication sessions. The AI module can be configured to produce insights, and/or identify patterns, and/or discover relationships, in the communication from the participant and/or the conductor interface. A plan generator is used in some embodiments to generate new session plans and/or adjust existing session plans based at least partially on the products of the AI module. The system can be configured to match a suitable session plan to at least one conductor based at least partially on the products of the AI module.

The system comprises in some embodiments the computer devices of the at least one conductor and the at least one participant configured for direct data communication with the server and/or over a data/computer network. The system can comprise a database accessible at least by the server for storing the repository with the plurality of session-plans and a respective plurality of session datasets associated with said plurality of session-plans, and for communicating selected at least one of the plurality of session-plan and/or session datasets at least to the computer device of the at least one conductor. The database comprises in some embodiments guiding notes data records storing guiding comments/tips to be presented in the conductor interface during steps and/or sub-steps of communication sessions. The database can comprise session summary/report data records storing at least one of the following: indication of steps conducted during communication session, information/content items presented to the participant(s) in each conducted step and/or sub-step of the session plan, data concerning the interactions between conductor(s) and participant(s) during a communication session, time intervals required for each step and/or sub-step of a communication session, scores associated with conducted communication sessions and/or the at least one conductor, records of entire or partial previously conducted communication sessions. The database can comprise project data records storing project information characterizing the certain information/content, and/or agenda, and/or task/goal, and/or interaction process of a plurality of interpersonal communication session to be conducted using the plurality session plans.

In another aspect the present application is directed to a conductor interface configured to communication data to at least one participant interface operated in a computer device in accordance with a protocol defined by a selected session-plan, and to facilitate selection of information/content items associated with said selected session-plan for display in said participant interface. The conductor interface can be configured to send to the at least one participant computer device data usable to request a participant interface from the server. Optionally, the conductor interface comprises one or more timers configured to measure time durations associated with a certain topic, and/or step, and/or sub-step, and/or information/content item, of the selected session-plan. The conductor interface can comprise a tips display area configured to present to the at least one participant tips at least partially associated with the time durations measured by the one or more timers, and/or information/content of the session dataset used with the selected session plan, and/or step and/or sub-step of the selected session plan.

In possible implementations the conductor interface is configured to establish a video session for interpersonal interaction between a conductor using the conductor interface and at least one participant using at least one participant interface operated in a computer device in accordance with a session-plan comprising a plurality of session steps each of which being associated with at least one session dataset comprising information, and/or instructions, and/or content, associated with a theme of said session step. The conductor interface can accordingly comprise a session module configured to manage the interpersonal communication for carrying out session steps of the plurality of session steps of the session-plan, and to facilitate selection of information and/or content items and/or perform instructions of the at least one of the session dataset associated with the session-plan for display in the participant interface.

The conductor interface comprises in some embodiments a session content display area for presenting the information/content items associated with the selected session-plan. optionally, the conductor interface comprises an alert display area configured to display alerts based at least partially on a level of participation determined based on data communicated from the at least one participant interface. The conductor interface can comprise a reminder display area configured to present reminders at least partially associated with the information/content used with the selected session plan in accordance with a step and/or sub-step thereof. The conductor interface can be configured to present audio and/or visual data/signals of a conductor interacting with said conductor interface, and/or of a participant interacting with said participant interface.

In yet another aspect the present application is directed to a conductor computer device configured to communicate data with a server and at least one participant computer device, wherein the conductor computer device comprises the conductor interface according to any of the embodiments disclosed hereinabove or hereinbelow, and a session module configured to guide the communication with the at least one participant interface to follow the protocol defined by the selected session-plan. The conductor computer device can be configured to receive the selected session-plan, and/or the information/content items associated with the selected session-plan, from a server over a data/computer network.

Yet another aspect of the present application is directed to a participant interface configured to communication of data to at least one conductor interface operated in a computer device in accordance with a protocol defined by a selected session-plan, and to present in the computer device information/content items associated with the selected session-plan and selected for display therein utilizing said at least one conductor interface. The participant interface can be configured to present audio and/or visual data/signals of a conductor interacting with said conductor interface, and/or of a participant interacting with the participant interface.

In possible implementation the participant interface is configured to establish a video session for interpersonal interaction between a participant using the participant interface and a conductor using a conductor interface operated in a computer device in accordance with a session-plan comprising a plurality of session steps each of which being associated with at least one session dataset comprising information, and/or instructions, and/or content, associated with a theme of the session step, the conductor interface comprising a session module configured to manage the interpersonal communication for carrying out session steps of the plurality of session steps of the session-plan, and to present in the computer device information and/or content items associated with the selected session-plan and selected for display therein utilizing said at least one conductor interface.

A yet another aspect of the present application is directed to a participant computer device configured to communicate data with a server and at least one conductor computer device, wherein the participant computer device comprises the participant interface according to any of the embodiments disclosed hereinabove or hereinbelow.

A still yet another aspect of the present application is directed to a method of managing an interpersonal communication session between at least one conductor computer and at least one participant conductor. The method comprising operating in the conductor computer a conductor interface configured to use a session plan for guiding the interpersonal communication session to follow a defined protocol, operating in the participant computer a participant interface configured to communicate data with the conductor interface operated in the participant computer, and presenting in the conductor interface information/content items associated with the session plan for selection via the conductor computer, and receiving the selected information/content items and presenting them in the participant interface.

In some implementations the method for managing an interpersonal communication session between at least one conductor computer and at least one participant computer comprises operating in the conductor computer a conductor interface configured to use a session plan for guiding the interpersonal communication session to follow a plurality of session steps, each of which being associated with at least one session dataset comprising information and/or instructions, and/or content associated with a theme of the session step, manging in the conductor interface the interpersonal communication for carrying out session steps of the plurality of session steps of the session-plan, and for facilitating selection of information and/or content items and/or perform instructions of at least one of the session datasets associated with the session-plan for display in the participant interface, the participant computer a participant interface configured to communicate data with the conductor interface operated in the conductor computer, and receiving in the participant computer information and/or content items selected via the conductor interface and presenting them in the participant interface.

The method comprises in some embodiments at least one of the following: using the conductor interface to select the session plan from a plurality of session plans; using the conductor interface to send session initiation data to the participant computer, wherein the session initiation data configured to cause the participant computer to request the participant interface from a server; conducting steps and/or sub-steps of the session plan and presenting in the conductor interface specific information/content items associated with the step and/or sub-step being conducted; presenting in the conductor interface tips and/or reminders and/or alerts associated with the conducted communication session; processing and analyzing communication from the participant interface to determine a level of participation and generating the tips and/or the reminders and/or the alerts at least partially based on the determined level of participation; analyzing communication from the conductor interface to determine one or more session progress parameters and generating the tips at least partially based on the determined one or more session progress parameters; analyzing previously conducted interpersonal communication sessions and updating at least one of the plurality of session plans and/or information/content items associated therewith accordingly; receiving via the conductor interface instructions to move the session plan to a previously conducted step sub-step, or to another step sub-step not yet conducted in the conductor interface; presenting in the conductor interface information/content items associated with an objection received from the participant interface.

The method can comprise an authentication step configured to permit transmission of the conductor interface to the conductor computer upon successfully performing the authenticating step. The method optionally comprises using the conductor interface to send to the participant interface at least one of the following: offer for sale, price proposal, legal documents, documents for signature.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings. Features shown in the drawings are meant to be illustrative of only some embodiments of the presently disclosed subject matter, unless otherwise implicitly indicated. In the drawings like reference numerals are used to indicate corresponding parts, and in which:

FIGS. 1A and 1B schematically illustrate interpersonal communication systems according to some possible embodiments, wherein FIG. 1A exemplifies use of a session plan in the interpersonal communication and FIG. 1B exemplifies use of a database;

FIG. 2 schematically illustrates an interpersonal communication session according to some possible embodiments;

FIG. 3 schematically illustrates an interpersonal communication system according to possible embodiments;

FIGS. 4A to 4D schematically illustrate display screens of the conductor interface according to some possible embodiments; and

FIGS. 5A to 5C schematically illustrate participant and conductor session screens according to some possible embodiments, wherein FIG. 5A shows the participant session screen during a session, FIG. 5B shows the participant session screen during chat data exchange, and FIG. 5C shows the conductor session screen during a session.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Elements illustrated in the drawings are not necessarily to scale, or in correct proportional relationships, which are not critical. Emphasis instead being placed upon clearly illustrating the principles of the presently disclosed subject matter such that persons skilled in the art will be able to device management of online interpersonal communication interactions, once they understand the principles of the subject matter disclosed herein. This presently disclosed subject matter may be provided in other specific forms and embodiments without departing from the essential characteristics described herein.

In a broad aspect the present application provides system and method for managing interpersonal communication interactions by directing the presenter, and/or the communication interaction session, through a sequence of predetermined steps of a session-plan. Optionally, but is some embodiments preferably, the session plan is designed to convey information, and/or promote a predetermined agenda, and/or achieve a desired goal, and/or implement in real-time a certain methodology for improving/serving a certain interaction. Each step of the session-plan can be directed towards a certain theme associated with the information being conveyed, and/or the predetermined agenda, and/or the desired goal of the session-plan, and/or configured to educate the audience (e.g., class, students, trainees, consumers, patients, etc.) and establish mutual understanding/agreement therewith about the theme of the specific step of the session-plan.

The session-plan may preferably, but need not necessarily, be configured to guide the presenter, and/or the communication tools thereby used, to convey to the audience in real-time information associated with the theme of the specific step of the session-plan being conducted, and/or present/display to the audience in real-time shareable content related to the certain theme of the step. The various steps of the session-plan can be further configured to encourage interpersonal interactions of different characteristics e.g., discussions, debates, quarrels, appreciation/sympathy, between the presenter and the audience, in connection with the specific theme of the step. For this purpose, the presenter can be provided in each step of the session-plan with a set of shareable content (e.g., images, video clips, songs/musical pieces, banners/flags, emojis/emoticons, documents, or suchlike) associated with the specific theme of the current step, and/or comments and/or tips. Each step can be configured to allow the presenter to select and share with the audience appropriate items from the set of shareable content provided in association with the current step and/or characteristics of the interpersonal interaction achieved with the audience in the current step.

Optionally, one or more items from the set of shareable content provided in association with the current step are dictated by the system for presenting to/sharing with the audience in the specific step conducted. Preferably, but need not necessarily, the presenter is given the liberty to select one or more items from the set of shareable content provided in association with the current step for presentation to/sharing with the audience in accordance with the progress achieved in the step being conducted in conveying the specific theme, and/or educating the audience, and/or reaching understandings therewith, and/or the characteristics of the interpersonal interactions developing between the presenter and the audience, and/or between two or more groups within the audience, during the duration of the step.

The steps of the session-plan can be configured for receiving and addressing in real-time questions and comments from the audience e.g., about the specific theme of the step, and/or the information being conveyed, and/or the items of the shareable content presented/shared. In possible applications an interpersonal communication session conducted in accordance with at least some of the steps of the session-plan concludes in assessment of the presenter's performance throughout the communication interaction session, and/or generating of one or more scores indicative of the amount of information conveyed and/or of the efficiency of conveying the information to the audience and/or of the efficacy in promoting the predetermined agenda and/or reaching a desired goal of the session-plan. A session summary/report can be accordingly generated for the presenter for improving future communication interactions, and/or for evaluation by the presenter's supervisors. Optionally, the entire session, or some portion thereof, is recorded and accessible for view/review by the conductor(s) and/or their supervisor(s).

The session-plan can be constructed as a simple concatenation of consecutive predefined steps specially designed for the communication interaction, or in a form of a more sophisticated flowchart having one or more bifurcations and decision-making junctions, designed to convey information of interest, and/or promote the predetermined agenda, and/or direct the communication interaction towards a desired goal/outcome, of the session plan.

In some embodiments a web video platform/system is used to allow a presenter an adaptive remote video meeting with the audience. The web platform can be configured to utilize a predetermined process/flow (i.e., the session-plan) for directing the video meeting through the predefined steps and adapt the communication interaction session between the presenter and its audience to comply with/promote a preset methodology/agenda.

For example, in the world of sales, the web video platform/system can be configured to use a universal four-step session-plan methodology that requires the presenter e.g., salesperson to work according to the predefined steps and perform the video meeting to promote the predetermined methodology/agenda of the session-plan. As another example, in remote teaching applications, the web video platform/system can be configured to direct the presenter e.g., teacher/lecturer to follow predefined steps of a predetermined lesson/session-plan adapted to maximize students' participation and motivation in the learning process thereby promoted. For example, the session-plan may be configured for carrying out customer service interpersonal communications e.g., for directing a user to solve a certain problem.

The communication interaction management techniques disclosed herein are designed to improve the audiences' experience, and optionally, but in some embodiments preferably, to achieve a desired goal e.g., learning curve, practicing/exercising, treating a condition/ailment, increase interest in a product/service and/or enhance conversion rate. For example, the embodiments disclosed herein can be configured to support salespersons at all stages of a video (or non-video) commerce sale process, and/or help to improve the video (or non-video) commerce sale process and improve the chances to close a deal, enhance the conversion rate, and/or upgrade the customer's experience.

In some embodiments the web-based video meeting platform is designed as a web-based (e.g., client-server) application that can be executed by any readily available web-platform/computer that supports any browser (e.g., Safari, Mozilla Firefox, Google Chrome, or suchlike), without the need to download and/or install any software at the presenter's side or at the audience side. This way the web-based video meeting platform can be accessed by any computer device (e.g., PC, laptop, smartphone, tablet, and suchlike), simply by clicking a link, or typing a uniform resource locator/URL or internet-protocol/IP address in the address bar/field of the web browser. In some embodiments a link to the web-based application is sent to mobile phones of the audience e.g., via short-message-service/SMS, WhatsApp, email, or any other text messaging application/service available.

The web-based application is configured in some embodiments to provide a wide range of options, enhance the audience experience e.g., in video commerce: customize products/services by providing salespersons with an adaptive real-time video support environment that supports every step of the sale process, improve conversion rate starting at the lead and proceeding to meeting. This way, interested parties are able to arrange and initiate meetings without leaving their household/premises.

Interpersonal communication interactions are mainly based nowadays on the instincts and the interpretations of the presenter. By utilizing the session-plan disclosed herein to conduct such interpersonal communication interactions, each session yields a set of data records that can be processed and analysed to derive insights in real time and in retrospect, where each word spoken, verbal intonation, body language gesture, plan or data presented, objection or topic raised is identified and recorded in an audience dataset of the session, from which one can objectively learn, on one hand about the audience participation and/or interest, and on the other hand on the functioning and/or competence of the presenter.

The web-based application is configured in some embodiments to display visual content to the customer e.g., photos, videos, documents, etc. which is catalogued according to the real-time steps of the session-plan that can be operated through a highly social/user-friendly interface e.g., using a drag and drop approach for selecting a desired content from a pool of shareable content associated with the current step of the session plan, and dragging with a pointing device (e.g., computer mouse) onto a display section of the audience. The web-based application may preferably, but need not necessarily, implement a real-time dynamic methodology adaptive video conferencing display system taking into account various inputs, parameters (in real time or offline), such as, but not limited to:
1. decreased audience attention;
2. talking ratio between the presenter and the audience, which usually indicates a lack of listening;
3. skipping or moving too fast through a step of a specific theme (e.g., a topic or sub-topic) that is essential for the information being conveyed, and/or the agenda being promoted, and/or the desired goal of the session plan;
4. reminders tailored into the steps of the session-plan for the presenter to convey important highlights and/or data content that are relevant to the topic of the meeting and/or to the specific step of the session-plan that is currently being conducted; and/or
5. objections: resolving correctly and accurately objections raised in real time with visual means that support the solution.

It is noted in this respect that for each step of the session-plan there may be a certain pool (also referred to herein as step content) of information and/or shareable content items, which is fetched in each step for presentation to the participant(s) by the conductor during the step duration. Objections may be raised by the participant(s) during any step of the session-plan, and accordingly a specially prepared objection's pool (i.e., objection's content) of information and/or shareable content media is made available in some embodiments for presentation for the conductor(s) at all steps of the session-plan in case of raised objections. The web-based application may preferably, but need not necessarily, gather and process information aggregated in the system from multiple other interpersonal communication interaction sessions e.g., carried out worldwide, as well as from the audience and/or the specific presenter, and use it as an infrastructure (study dataset) for artificial intelligence (AI) analysis. AI analysis can be used in possible embodiments to gain insights, and/or identify patterns, and/or discover relationships, in the communication interaction data aggregated over time that can guarantee successful promotion of the agendas and/or reaching the goals of the session-plans. AI analysis can be further employed for automation of certain actions and/or to identify trends and/or goals of the audience, and/or better understand the audience and adjust the session-plans accordingly to improve goal(s) of the presenter and/or the audience.

For example, and without being limiting, in possible applications the session-plans used in the communication interaction sessions are designed for one or more of the following: answering questions of one or more participants from the audience about the theme/agenda, resolving correctly and accurately objections in real-time utilizing audio and/or visual and/or textual means configured to support the solution, understanding speech and language intonations and recognizing faces and body language of both presenters and audience participants, identifying and recommending the best plan-session for promoting a certain agenda and/or achieving a certain goal e.g., based on the data aggregated in the system from past communication interaction sessions.

Optionally, but in some embodiments preferably, the system is configured to study both the presenter and the audience participating in the interpersonal communication interaction, and/or all the information aggregated therein, and determine, select or construct, based thereon a specially tailored session-plan, and/or agenda, and goal, e.g., an ideal product (property) for a customer. For this purpose, the system is configured in some embodiments to: study and identify, understand and interpret, body language, gestures (and issue respective alerts, tips and/or recommendations, if needed), speech and verbal intonations and their meanings (and issue respective alerts if so needed); recommend to a specific presenter a preferred, or specially tailored, session-plan for maximizing the presenter's abilities to convey certain information and/or promote a certain agenda and/or achieve a certain goal e.g., a plan designed for a specific salesman e.g., including sales stages/steps, time intervals for each stage/step, and/or how to conduct the stages/steps and which information/content to present based on study of previous communication interaction sessions), recommendation about the specific asset (based on previous study and system insights).

In possible applications the system is configured to allow the participants to carry out one or more of the following: sign documents e.g., secure digital signature; quick and secure payment clearing; transfer a quote to the participant/customer; place illustrations and/or marks on the screens' of participants; recording of at least a portion of the communication interaction session; define workflow/session-plan for the entire session depending on the agenda/goal e.g., product for sale; measuring time intervals for each stage/step of the session and/or presented information and/or shareable content item of the step e.g., sale process; view/present shareable content e.g., video clips, photos, live video, for example, for presenting to a customer, in a drag and drop and share screen; provide a pleasant and simple flap-display/board for users lacking technological background.

For an overview of several example features, process stages, and principles of the subject matter disclosed herein, the examples of web-based interaction communications illustrated schematically and diagrammatically in the figures are oriented towards video commerce. These web-based systems are shown as one example implementation that demonstrates a number of features, processes, and principles used for video commerce applications, but they are also useful for other applications (e.g., customer service, medical treatment, remote lecture/lesson) and can be made in different variations. Therefore, this description will proceed with reference to the shown examples, but with the understanding that the presently disclosed subject matter recited in the claims below can also be implemented in myriad other ways, once the principles are understood from the descriptions, explanations, and drawings herein. All such variations, as well as any other modifications apparent to one of ordinary skill in the art and useful in digital interpersonal interaction applications may be suitably employed and are intended to fall within the scope of this disclosure.

Interpersonal communication sessions according to embodiments disclosed herein utilize a session plan configured to guide at least one conductor to carry out at least some steps and/or sub-steps (topic) of the session-plan in which information, and/or shareable content, associated with each one of the steps and/or sub-steps, is conveyed to at least one participant. Preferably, but need not necessarily, the information and/or shareable content conveyed to the at least one participant is associated with a theme of the step of the session being conducted. Optionally, but in some embodiments preferably, the session plan is configured to covey certain information and/or promote a certain agenda and/or achieve a certain goal, and the theme associated with each step of the session plan is adapted to provide a desired incremental progress in conveying the certain information/content and/or promoting the certain agenda and/or achieving the certain goal of the session plan.

In some applications each step of the session plan is configured to provide the at least one conductor with a dataset associated with the theme of the step of the session plan being conducted. The dataset of each step can include instructions and/or information and/or shareable content for conveying to the participants in accordance with the respective theme of the step. The at least one conductor can be guided according to the instructions to convey the respective information and select one or more items of the shareable content for presentation to the at least one participant with, or without, association to the current step of the session plan that is being carried out.

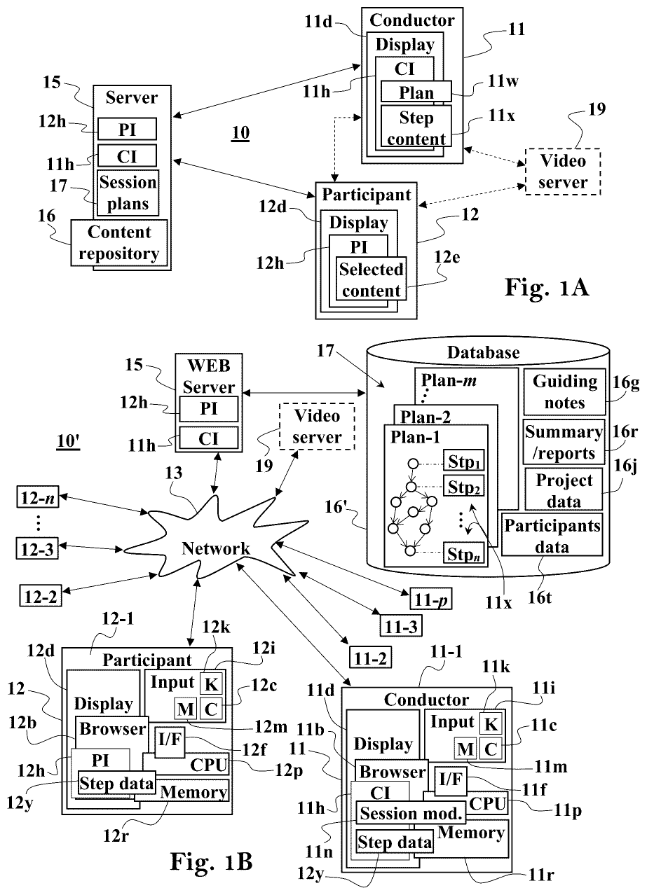

FIG. 1A schematically illustrates a system 10 for conducting interpersonal communication sessions between at least one conductor and at least one participant. The conductor(s) is in some embodiments the initiator of the communication session, and the conductor(s) can be also responsible to develop a dialog with the participant(s) to convey the needed information and/or promote the agenda and/or reach the goal of the communication session. The system 10 comprises a server (e.g., API-application programming interface) computer 15 configured to communicate data with at least one conductor computer 11 and at least one participant computer 12. The server 15 is configured to receive requests from the conductor and participants computers 11,12 and transfer corresponding data thereto. The server 15 comprises at least one conductor interface (CI) 11h and at least one participant interface (PI) 12h, one or more session plans 17, and a content repository (e.g., database) 16 for storing information and/or one or more session datasets respectively associated with the one or more session plans 17. Optionally, the session plans 17 are also stored in the repository 16.

The server 15 can be implemented by any web/data server (e.g., supporting hypertext transfer protocol—HTTP, file transfer protocol—FTP, such as Apache, Microsoft's internet information services—IIS, Nginx, or suchlike). The conductor and/or participant computers 11,12 can be implemented by computerized devices cable of communicating data with the server 15 e.g., personal computers-PCs, laptops, and smart devices such as smartphones, smartTVs, tablets, or suchlike. The communication between the server 15, the conductor computer 11 and the participant computer 12, can be carried out over any suitable communication medium (e.g., landline and/or cellular telephony and/or cables and/or optical fibers infrastructures, satellites, etc.) e.g., via one or more data/computer networks utilizing any suitable data/signals communication protocols, such as transmission control protocol (TCP), user datagram protocol (UDP), internet control message protocol (ICMP), and suchlike, preferably, but need not necessarily, over the Internet.

Interpersonal communication sessions according to embodiments hereof are carried out utilizing the conductor and participant interfaces (e.g., implemented by web pages comprising graphical user interfaces-GUIs designed to conduct the communication sessions and control performance of session plan steps) 11h, 12h provided by the server 15 to the conductor and the participant computers 11,12 respectively e.g., upon request. The conductor and participant computers 11,12 comprise respective display devices 11d,12d for displaying the interfaces 11h,12h using suitable computer software programs e.g., web browsers. The server 15 is further configured to provide the conductor computer 11 a session plan 11w configured to guide the conductor and its interface 11h through a set of predefined steps of the session plan and provide respective step content 11x associated with each step of the session plan 11w.

The conductor(s) interface 11h is configured to establish audio and/or visual (e.g., video, for example, via a video server 19) communication with the participant(s) interface 12h, retrieve a determined session plan 11w from the session plans 17 stored on the server 15, follow the steps of the session plan 11w and retrieve from the content repository 16 of the server 15 the step content 11x comprising instructions and/or information and/or shareable content items (e.g., images, video clips, songs/musical pieces, banners/flags, emojis/emoticons, or suchlike) associated with the respective step being carried out in the session. The conductor can use the interface 11h to develop a dialogue with the participants concerning the information topic, agenda, and/or goal of the session. In each step of the session plan 11w the conductor interface 11h presents to the conductor in the display 11d the respective instructions and/or information and/or shareable content items of the step content 11x and allows the conductor to choose therefrom the content/information to be conveyed to the participant computer(s) 12 for display in the participants display device 12d.

The participant(s) interface 12h is configured for carrying out the audio and/or visual (e.g., video) communication with the conductor(s) interface 11h, and receive from the conductor(s) interface 11h instructions to display in each step in the display device 12d the information and/or shareable content item selected by the conductor(s) from the step content 11x. Optionally, but in some embodiments preferably, the participant(s) interface 12h is configured to receive from the conductor(s) interface 11h instructions to fetch the information and/or shareable content items selected by the conductor(s) from the content repository 16 e.g., of the server 15, and accordingly send one or more requests to the server 15 for the selected information and/or shareable content items. The server 15 can be accordingly configured to receive the requests from the participant(s) interface 12h and transmit to them the requested information and/or shareable content items for display in the display device 12d.

Alternatively, the server 15 can be configured to receive the instructions from the conductor(s) interface 11h to transmit to the participant(s) interface 12h the selected information and/or shareable content items, and accordingly fetch the selected information and/or shareable content items from the content repository 16 and send the same to the participant(s) interface 12h for display in its display device 12d. Optionally, but is some embodiments preferably, the conductor(s) interface 11h is configured to transmit the selected information and/or shareable content items directly (shown by dashed-arrowed line) to the participant(s) interface 12h for display in its display device 12d.

The server 15 can be configured to provide the conductor computer 11 the conductor interface 11h after an authorization process is carried out to verify the conductor has the required permissions to carry out communication session by the system 10. In some embodiments the conductor interface 11h is configured to send an invitation (e.g., a URL/link) to at least one participant computer 12. The invitation can be configured to cause the at least one participant computer 12 opening (clicking) it to send a request to the server 15 to participate in the interpersonal communication session. The server can be accordingly configured to provide the participant interface 12h to the at least one participant computer 12 upon receiving therefrom the request initiated via the invitation from the conductor computer 11.

FIG. 1B schematically illustrates an interpersonal communication system 10′ according to some possible embodiments between a plurality of conductors' computers 11-1, 11-2, 11-3, . . . , 11-p (collectively referred to herein as conductors' computers 11, where p>0 is an integer number), and a plurality of participants 12-1, 12-2, 12-3, . . . , 12-n (collectively referred to herein as conductors' computers 11, where n>0 is an integer number). It is noted that the system 10′ can be similarly configured to conduct one-to-one, one-to-many, many-to-one, or many-to-many, interpersonal communication interactions. In this non-limiting example, an external database 16′ is used for storing and provisioning a plurality of session plans Plan-1, Plan-2, . . . , Plan-m (where m>0 is an integer number), to one or more of the conductors' computers 11 and of the participants' computers 12 via the server 15, over a data/computer network 13 (e.g., the Internet). In possible embodiments the database 16′ is part of the web server 15.

The database 16′ can be further configured to store project data 16j, participants' data 16t, session summary/report data 16r, and/or session guiding notes data 16g. The project data 16j comprises detailed information (e.g., topics, goals, agendas) of a plurality of interpersonal communication session to be conducted using the one or more of the session plans Plan-1, Plan-2, . . . , Plan-m. The participants data 16t comprises one or more contact information (e.g., email address, telephone number, residence address, etc.) of potential participants that may be invited to participate in one or more of the interpersonal communication sessions conducted by the system 10′. The session guiding notes data 16g comprises guiding comments/tips that the system may present to the conductor during steps of communication sessions for improving the communication/dialogue with the participant(s) and/or the provision of information/shareable content items and/or the promotion of the agenda and/or achievement of the desired goal.

The session summary/report data 16r comprises indication of steps conducted during communication session utilizing the system, information/shareable content items presented to the participant(s) in each conducted step of the session plan, data concerning the interactions between conductor(s) and participant(s) during the session (e.g., questions asked, objections raised, and/or responses provided), time intervals required for each step and/or topic thereof, and/or a score assessing a level of success in conveying the required information to the participant(s), promoting the predetermined agenda, and/or achieving the desired goal of the session plan (Plan-i). Preferably, but need not necessarily, the session summary/report data 16r comprises entire or partial recorded communication sessions previously conducted between conductor(s) and participant(s) and made available for view/review by the conductor(s) and/or supervisors.

As seen in FIG. 1B, a participant computer 12 may further comprise one or more processors 12p and memories 12r, one or more input devices 12i (e.g., comprising a keyboard 12k, and/or a pointing device 12m such as a computer mouse, and/or a video camera 12c), and a communication interface (I/F e.g., Ethernet, WiFi, GSM, or suchlike) 12f configured for communication of data/signals over the network 13. Optionally, the display device 12d is implemented by a type of touchscreen that can be used to replace at least some of the components/functionality of the input devices 12i. In this non-limiting example, a web browser 12b is used to present the participant interface 12h in the participant's display device 12d, and at least some portion of the step data 12y selected by at least one of the conductors 12 during a step of a session plan.

Similarly, a conductor computer 11 may further comprise one or more processors 11p and memories 11r, one or more input devices 11i (e.g., comprising a keyboard 11k, and/or a pointing device 11m such as a computer mouse, and/or a video camera 11c), and a communication interface (e.g., Ethernet, WiFi, GSM, or suchlike) 11f configured for communication of data/signals over the network 13. Optionally, the display device 11d is implemented by a type of touchscreen that can be used to replace at least some of the components/functionality of the input devices 11i. A web browser 11b can be similarly used to present the conductor interface 11h in the conductor's display device 12d.

A session module 11n is used in some embodiments in the conductor computer(s) 11 to carry out successive steps of a selected one of the session plans Plan-1, Plan-2, . . . , Plan-m. The session plan (Plan-i) used by the conductor(s) may be selected by the conductor(s) via the conductor interface 11h, or by the web server 15, or by the application server 16′. The session module 11n is configured to fetch the step data 12y required for the current step of the session plan selected by at least one of the conductors 12 during a step of a session plan, present at least some portion of the fetched step data 12y in the conductor interface(s) 11h, and allow the conductor(s) to select one or more of information and/or shareable content items thereof for transmission and display in the participant interface(s) 12h.

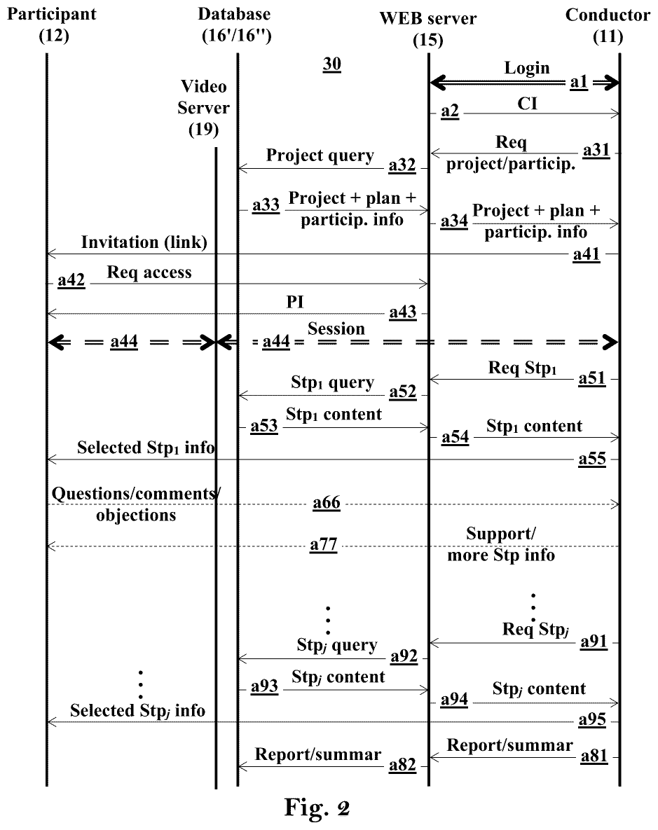

FIG. 2 is a sequence diagram exemplifying an interpersonal communication session 30 according to some possible embodiments. The communication session 30 can be initiated in a login step (a1) in which the web server (15) authenticates at least one conductor via its conductor computer (11). After authenticating the at least one conductor, the web server (15) sends (a2) to the conductor's computer (11) a conductor interface (CI e.g., web page) for execution by its web browser (11b). After the conductor interface (CI) is activated in the conductor computer (11), it may be used to issue one or more data query requests (a31) directed to the web server (15) for initiating an interpersonal communication session. The conductor may use the data query requests (a31) to receive project data (16j) and/or participants' data (16t). The data quey request are directed (a32) by the web server (15) to the database (16′/16″), which sends (a33) the requested data directly to the conductor computer (11), or to the web server (15), wherefrom it sent (a34) to the conductor computer (11).

In this non-limiting example the project (16j) and participant (16t) data is sent to the conductor computer (11) with one more session plans, but in possible embodiments the session initiating steps may include additional data request (not shown) sent to the web server for retrieving from the database a suitable session plan (Plan-i, where 1≤i≤n is and integer) for a project selected by the at least one conductor, and/or contact information of potential participants for which the selected project may be relevant.

After receiving from the database (16′) all the information/data required to conduct the interpersonal communication session, one or more invitations (a41 e.g., comprising a link/URL/IP-address) are sent to respective potential computer participants (12). The invitations (a41) may be sent to the potential participants as text messages (e.g., using emails, simple-text-services—SMS, WhatsApp, Linkedin, or suchlike). After the invitation is received, the participant(s) wishing to join the interpersonal communication session open/activate the invitation, for example, by clicking a link or typing a URL/IP address in an address field of a web browser, thereby causing transmittal of an access request (a42) to the web server (15). Upon receiving the access request (a42) the web browser (15) sends (a43) to the respective participant (12) a participant interface (PI e.g., web page) for execution by its web browser (12b). Once the participant interface (PI) is activated by the web browser (12b) of the participant's computer (12), audio and/or visual communication (a44 e.g., video meeting, for example, via the video server 19) is established between the participant(s) and conductor(s) computers via their respective interfaces, and the interpersonal communication session is commenced.

The conductors' interfaces (CIs) are configured to follow the steps of the session plan (Plan-i) selected for the particular session. As the session is commenced the conductor interface(s) send request(s) (a51) to the web server to fetch from the database (16′) step content (11x, information/instructions and/or shareable content items) associated with the first step (STP₁) of the session plan (Plan-i). The web server (15) conveys (a52) the requests to the database (16′), and thereafter conveys (a54) the step data (11x) received (a53) from the database (16′) to the conductor computer(s) (11). As a dialogue is developed between the conductor(s) and participant(s), the conductor interface(s) (CI) presents to the conductors information/instructions and/or shareable content items of the step data (11x) associated with the specific step of the session plan being carried out, for allowing the conductor(s) to select one or more information/shareable content items therefrom for display in the participant interfaces(s) (PI).

The information/shareable content items selected by the conductor(s) for display in the participant interfaces(s) (PI) is sent (a55) to the participant computer(s) (12) either directly, or indirectly (not shown) e.g., by sending respective links/instructions to the participant computer(s) (12) to request the selected information/shareable content from the web server (15) and its database (16′/16″). This process of sequentially fetching step data (11x) from the database (16′/16″) for steps of the session plan (Plan-i) being conducted, presenting the fetched step data (11x) to the conductor(s), and directing the participant interface(s) to present from the step data (11x) information/shareable content items selected by the at least one conductor(s), can be repeated until the last step is conducted (a91 to a95 of STPj where 1≤j≤n is an integer) and the communication session is terminated.

During the interpersonal communication session 30 one or more of the participant(s) can send (a66, e.g., via the video server) questions/comments/objections to the conductor(s), and the participant(s) may send (a77, e.g., via the video server) responsive data/support and/or further selectable information/shareable content items from the step data (11x) of the current step being performed. After the communication session is ended, a report/summary may be sent (a81) from the conductor computer(s) (11) to the web server (15) for storage (a82) in the database (16′). The summary/report may comprise a list of steps conducted, information/shareable content items presented to the participant(s) in each conducted step of the session plan, record of the entire or portion of the conducted interpersonal communication session, data concerning the interactions between conductor(s) and participant(s) during the session (e.g., questions asked, objections raised, responses provided), time intervals required for each step and/or sub-step/topic, and/or a score assessing a level of success in conveying the required information to the participant(s), promoting the predetermined agenda, and achieving the desired goal of the session plan (Plan-i).

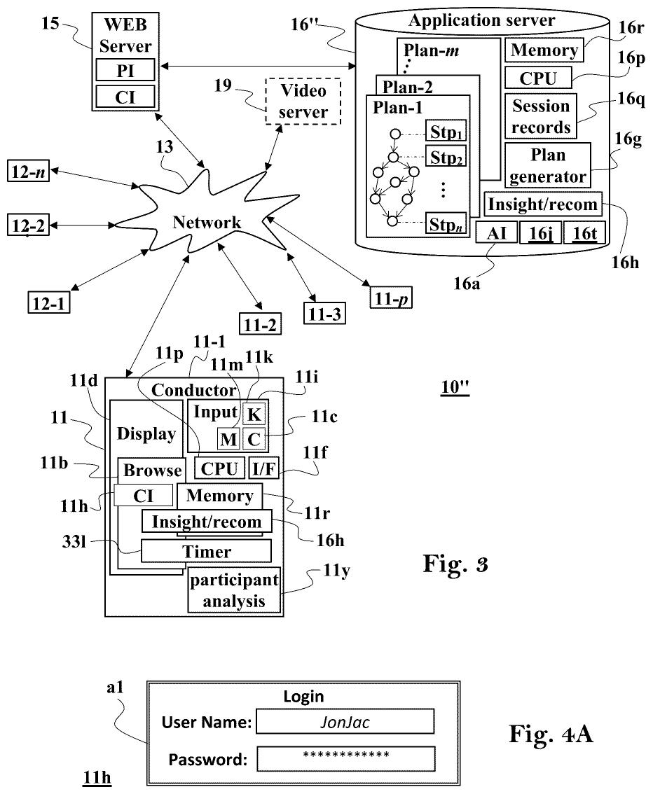

FIG. 3 schematically illustrates an interpersonal communication session system 10″ according to some possible embodiments. System 10″ is similar to system 10′ of FIG. 1B but comprises few additional components and features for improving the efficacy of the interpersonal communication sessions and its ability to achieve desired outcomes. For example, a participant analysis module 11y is executed in some embodiments in the conductor's computer 11 for processing and analyzing the communication received from the participant's interface (12h) and determining a participation level indicative of the participant's involvement, interest and/or collaboration, in the dialogue with, and/or the information/shareable content items presented by the conductor. Optionally, but in some embodiments preferably, the participant analysis module 11y is configured to process and analyze the communication from the conductor's interface (11h) and generate tip and recommendations to the conductor accordingly e.g., too much/little time is allotted to a certain step, or sub-step, or information/content items. The participant analysis module 11y can be configured to determine the participation level based on analysis of participant's utterance, verbal intonations, body language gesture, and/or asked questions, etc.

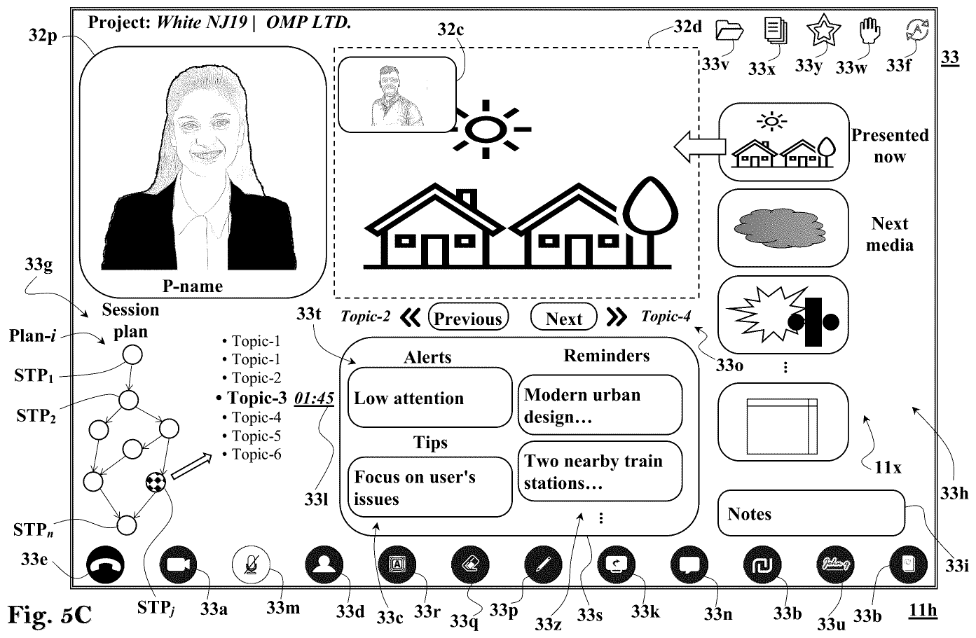

The system is configured in some embodiments to generate alerts, comments, tips and/or recommendations for the conductor based on the participation level determined by the participant analysis module 11y e.g., presented in the alerts and/or recommendation sections 33t,33z shown in FIG. 5C. The alerts, comments, tips and/or recommendations, generated by the participant analysis module 11y may be recorded as insights and recommendations data 16h in the database/application server 16″. The system may also maintain in the database 16″ session records 16q along the insights and recommendations data 16h with additional information obtained over time from numerous interpersonal communication sessions carried out by the system 10″, including, but not limited to, chat messages, dialogues between participant(s) and conductor(s), sessions outcome, and suchlike, in the respective steps (STPⱼ) of the session plans (Plan-i) used. The repository 16 (of FIG. 1A), databases 16′ (of FIG. 1B) and database 16″ (of FIG. 3), are generally referred to herein as database 16.

Preferably, but need not necessarily, an artificial intelligence (AI) module 16a is used e.g., in the database/application server 16″ for gaining insights, and/or identify patterns, and/or discover relationships, based on the session records 16q and/or insights and/or recommendations data 16h aggregated over time in the database 16″. The AI module 16a may be further used to determine based on the data aggregated in the database 16″ a score for each conductor indicative of the fulfilment, amount of information conveyed and/or of the efficiency of conveying the information to the participant(s).

The products of the AI module 16a can be recorded together with the insights and recommendations data 16h in the database 16″. A plan generator module 16g is used in some embodiments to generate new session plans, and/or to update existing session plans, in the database 16″, based on the data aggregated in the insights and recommendations data 16h and/or the session records 16q. The plan generator module 16g may be further configured to match a suitable session plan to each conductor based on the scores, insights, comments and/or recommendations in the insights and recommendations data 16h.

Optionally, but in some embodiments preferably, one or more timers 331 are used e.g., in the conductor computer(s), to measure time durations required for each topic being discussed/presented/conducted to the participant(s), and/or time duration of each step and/or sub-step of the session plan being used for the interpersonal communication session. The various time topics/steps time durations may be used by the system to generate comments, tips, insights and/or recommendations, which may be presented to the conductor(s) in real-time during the communication session and/or recorded together with the session data 16q and/or the insights and recommendations data 16h in the database 16″. The recorded topic/steps time durations can be used by the AI module 16a in generation of its products, and/or by the plan generator 16g in the generating/updating of session plans and/or matching session plans to the conductor(s).

### EXAMPLES

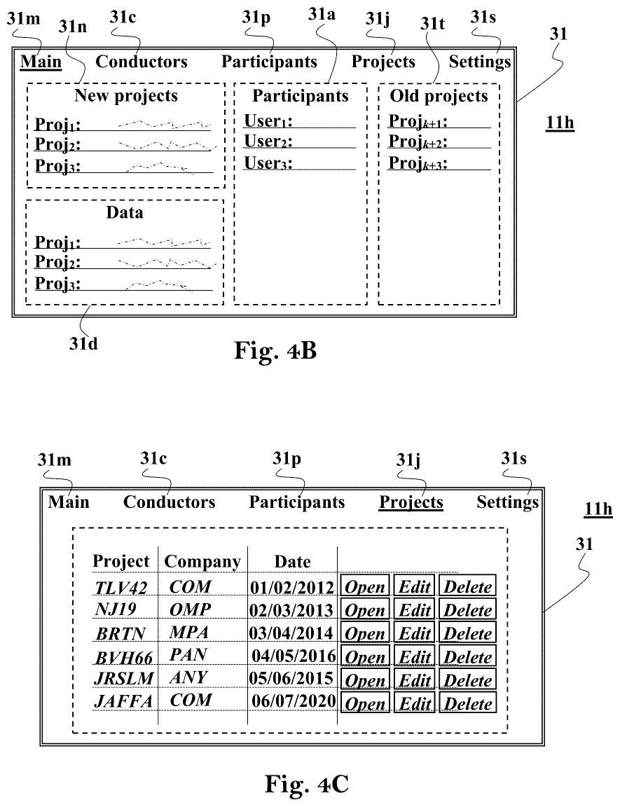

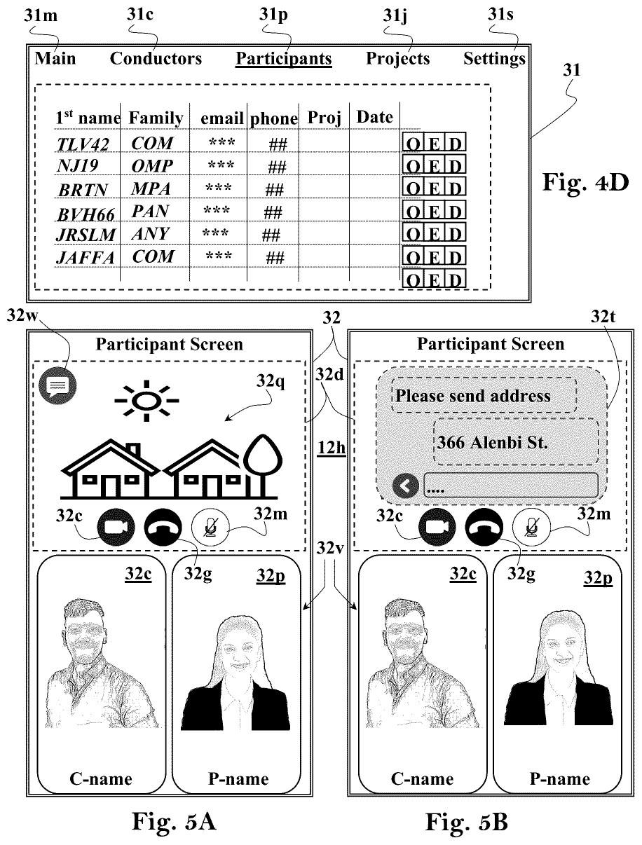

The presently disclosed subject matter will be described below in greater detail with reference to FIGS. 4 and 5 by way of specific examples directed to a one-to-one video commerce application. The following examples are offered for illustrative purposes only and are not intended to limit the presently disclosed subject matter in any manner. Those of skill in the art will readily recognize a variety of non-critical parameters that can be changed or modified to yield essentially the same results.

FIGS. 4A to 4C show various screens of a specific and non-limiting e-commerce implementation of the conductor interface (IC, 11h). FIG. 4A exemplifies a login screen (a1) usable for authenticating the conductor by entering correct username and password in the respective fields. FIG. 4B exemplifies a main screen 31 that can be presented to the conductor upon successful logging-in (a1), retrieval and opening/activation (a2) of the conductor interface (11h) in a web browser (11b), and receipt (a31 to a34) of the project data (16j) and of the participants data (16t). The main screen 31 comprises in some embodiments a Main screen tab 31m for showing new projects 31n and brief information thereabout 31d, Participants identifiers (e.g., names) 31a, and Old projects 31t. The main screen 31 further comprises a Conductors tab 31c for presenting detailed information of conductors that are logged-in the system, a Participants tab 31p for presenting detailed information about participants interested in one or more of the projects, a Projects tab 31j for showing detailed information about the projects, and a Settings tab 31s for adjusting settings of the conductor interface 11h.

FIG. 4C exemplifies the Projects tab 31j of the main screen 31, in which the projects information is shown in form of a table comprising Project name field, a Company name field, a Date field, and Open, Edit and Delete buttons for each of the projects. FIG. 4D exemplifies the Participants tab 31p, in which the participants information is also arranged in a table comprising a (first) 1st name field, a Family name field, email address field, phone number field, project field, Date field, and open (O), edit (E), and delete (D) buttons.

FIGS. 5A to 5C exemplify conductor's (11h) and participant's (12h) interfaces during an interpersonal communication session according to some possible embodiments. The participant's session interface 32 shown in FIGS. 5A and 5B comprises an eye-to-eye video meeting portion 32v configured to display a conductor's video area 32c for showing a video stream acquired in real-time by the conductor's camera (11c) and a participant's video area 32p for showing a video stream acquired in real-time by the participant's camera (11c), and a common display area 32d for communicating data between the conductor and the participant that is concurrently presented to all parties of the communication session. Optionally, the name of the conductor (C-name) is displayed in, or near, the conductor's video area 32c, and/or the name of the participant (P-name) is displayed in, or near, the participant's video area 32p.

In FIG. 5A the common display area 32d shows an asset 32q presented by the conductor to the participant, which may be offered for sale. In FIG. 5B a chat box 32t is opened in the common display area 32d e.g., by the participant clicking on the chat button 32w, and textual information is exchanged therein between the participant and conductor e.g., concerning the presented asset 32q. Additional press buttons may be provided in the participant's session interface 32, such as, for example, turn camera on/off button 32c, turn microphone on/off button 32m, and an end session button 32g. The press buttons are shown in this example in the common display area 32d, but they can be placed in any other location within the participant's session interface 32.

FIG. 5C shows conductor's session interface 33 generally comprising one or more of the following: the participant's video area 32p showing the video stream acquired in real-time by the participant's camera (11c) together with the name (P-name) of the participant; the common display area 32d for communicating data between the conductor and the participant that is concurrently presented to all parties of the communication session; a session content area 33h for displaying session e.g., information/shareable content items of the step content 11x associated with the specific step STPⱼ of the session plan being conducted; a topic navigation area 330 for the conductor to navigate between different topics/sub-steps related to the current step (STPⱼ) of the session plan (Plan-i) being conducted; a conductor's guidance area 33s for displaying guiding information (e.g., from the session guiding notes data 16g of the database 16′) to the conductor during steps (STPⱼ) of the session plan (Plan-i) being conducted; a notes placement area 33i for the conductor to place notes concerning the communication session being conducted; and/or a step progress area 33g showing information about the current step (STPⱼ) of the session plan (Plan-i) being conducted.

As seen, in some embodiments the common display area 32d of the conductor's session interface 33 is further configured to show the conductor's video area 32c with the video stream acquired in real-time by the conductor's camera (11c). The session content area 33h can be configured to present to the conductor all of the information/documents/shareable content items fetched from the database (16′) in connection with session and/or the current step (STPⱼ) of the session plan (Plan-i) being conducted. Preferably, but need not necessarily, the conductor's session interface 33 is configured to allow the conductor to select an item (e.g., Next media) from the step content area 11x presented in the session content area 33h and drug and drop it inside the common display area 32d for presenting the same to the participant. The conductor is given the liberty to choose any item from the session content area 33h as found appropriate in accordance with the progress and/or dialogue achieved so far in the current step (STPⱼ) and/or the entire communication session.

The step progress area 33g can be configured to show a diagram of the session plan (Plan-i) that is being followed by the communication session, highlighting the current step (STPⱼ) being carried out, and/or a list of topics/sub-steps Topic-1, Topic-2, . . . , Topic-6, the conductor is expected to discuss in each step. The conductor's session interface 33 can be further configured to highlight the current topic (e.g., Topic-3 shown enlarged and in bold letters) being discussed in the step. Optionally, but in some embodiments preferably, the conductor's session interface 33 is further configured to show a timer 331 indication (01:45 in the shown example) of the time interval passed since the start of the discussion of the current topic. The timer indication 331 is configured to show the participant the amount of time being spent on each topic, to ensure that too much, or too little, time is not being spent on a certain topic, for keeping the communication vibrant and interesting to the participant i.e., for not boring the participant.

The topic navigation area 330 provides the conductor a Next push button with an indication of the next topic (Topic-4 in this example) for the conductor to inform the system that the discussion in the currently conducted step (STPⱼ) is being changed to the next topic, and a Previous push button with an indication of the previous topic (Topic-1 in this example) for the conductor to inform the system that the discussion in the currently conducted step (STPⱼ) is being changed back to the previous topic.

The conductor's guidance area 33s comprises in some embodiments an Alerts section 33t in which alerts are presented by the system to the conductor. The alerts presented to the conductor in the Alerts section 33t are configured to bring to the conductor's attention observations made by the system with respect to the attention of the participant and/or participant's involvement in the topic being discussed e.g., certain content should be presented, too much, or too little, time is given to a certain step and/or sub-step/topic and/or content. For this purpose, the system comprises in some embodiments a participant analysis module (11y e.g., at the conductor computer 11, and/or the participant computer 12, and/or web server 15, and/or the application server 16″) configured to determine a participant's level of involvement in the discussion/dialogue based on participant's utterance, verbal intonations, body language gesture, etc.

The conductor's guidance area 33s can further comprise a Reminders section 33z for presenting to the conductor information in connection with the topic/sub-step being discussed and/or the information/shareable content items being presented to the participant. The reminders presented in the Reminders section 33z may be embedded in the step content 11x data obtained from the database (16′) for each step STPⱼ. The conductor's guidance area 33s can further comprise a Tips section 33c for presenting to the conductor guiding information for improving the conducted session and performance of the steps and/or sub-steps of the session plan.

The conductor's session interface 33 may further provide a plurality of push buttons, including, one of more of the following: an end session button 33e; turn camera on/off button 33a; turn microphone on/off button 33m; add participant button 33d; a text box button 33r configured to add text box to the presented media; add annotations button 33p configured to add annotations in the session interface 33 e.g., to the presented media; an erase annotation push button 33q configured to erase annotations made in the session interface 33; an open chat box button 33n to open the chat box (32t) with the participant; a payment button 33b for opening a payment window (not shown) for the participant to pay (e.g., via the server 15) for goods/services purchased during the communication session; a signature button 33u for signing documents electronically (e.g., via the server 15); and/or a price proposal button 33b configured for preparation of a price proposal document.

Further push buttons may be provided in the conductor's session interface 33 for managing aspects of the communication session and the content presented in the session content area 33h, including for example: an open directory button 33v configured for accessing files/directories in the database (16) e.g., the step content 11x; a document import button 33x configured for accessing/fetching documents relevant to the project/communication session carried out (e.g., legal documents/agreements, contracts, price proposals, etc.) e.g., from the database (16); a favorites button 33y configured for accessing/fetching information/content items considered by the designers, managers and/or conductors of the system to be favorable for the project/communication session being carried out; an objections button 33w for accessing/fetching information/content items that a priori prepared for resolving/answering objections raised by the participant; and/or an automation button configured for automatic loading of the corresponding information/content items into the session content area 33h each time the Next or Previous push buttons in the topic navigation area 330 are pressed by the conductor.

Accordingly, the information, documents and/or shareable content items displayed in the session content area 33h is changed corresponding to the conductor's pressing on the press buttons 33v, 33x, 33y or 33w. Since objections may be raised by participants at any step or sub-step of the session plan, the database 16 may be configured to maintain information/content items associated with objections expected from the participants and/or with objections previously raised in the same or similar projects/sessions, which may be also associated with specific steps and/or sub-steps of the session plan. Accordingly, upon pressing the objections push button 33w the system fetches from the database 16 the information/content items a priori prepared with association to the current step or sub-step of the session plan and present it to the conductor in the session content area 33h. Similarly, relevant tips can be loaded into the Tips section 33c of the conductor's guidance area 33s each time the objections push button 33w is pressed by the conductor, in accordance with the current step and/or sub-step. This way the conductor is quickly provided with material, tips and tools, to resolve objections raised by the participants during the communication sessions.

It is appreciated that steps disclosed of the process/methods herein may be realized as computer executable code created using a structured programming language (e.g., C), an object oriented programming language (e.g., C++), or any other high-level or low-level programming language (including assembly languages, hardware description languages, and database programming languages and technologies) that may be stored, compiled or interpreted to run on one of the above computer devices. The processing may be distributed across a number of computerized devices, which may be functionally integrated into a dedicated standalone session communication system. Software which implements aspects of the present disclosure can be stored on a media, such as flash memory/disk on key, diskette, tape or fixed disk, or optical media, such as a CD/DVD-ROM. Additionally or alternatively, the software can be supplied/downloaded to the conductors' and/or participants' computers via the Internet or any suitable data/computer network. All such permutations and combinations are intended to fall within the scope of the present disclosure.

The flowcharts and block diagrams in the different depicted embodiments illustrate the architecture, functionality, and operation of some possible implementations of apparatuses and methods according to an illustrative embodiment. In this regard, each block in the flowcharts or block diagrams may represent a software module, segment, and/or function, that may be implemented by program code, in hardware, or as a combination of software and hardware. When implemented in hardware, the hardware may, for example, take the form of integrated circuits (IC) and/or field programmable gate arrays (FPGAs), manufactured or configured to carry out one or more operations in the flowcharts or block diagrams.

It should also be understood that throughout this disclosure, where a process or method is shown or described, the steps/acts of the method may be performed in any order and/or simultaneously, and/or with other steps/acts not illustrated/described herein, unless it is clear from the context that one step depends on another being performed first. In possible embodiments not all of the illustrated/described steps/acts are required to carry out the method.

As described hereinabove and shown in the figures, the present application provides interpersonal communication management systems and related methods. While particular embodiments of the presently disclosed subject matter have been described, it will be understood, however, that the presently disclosed subject matter is not limited thereto, since modifications may be made by those skilled in the art, particularly in light of the foregoing teachings. As will be appreciated by the skilled person, the presently disclosed subject matter can be carried out in a great variety of ways, employing more than one technique from those described above, all without exceeding the scope of the claims.

1. A communication system comprising:
a server configured to between computer devices of a conductor and at least one participant,
a repository comprising content a plurality of session datasets and a plurality of session-plans, each one of said plurality of session-plans comprising a plurality of session steps, each one of said plurality of session steps being associated with at least one of said plurality of session datasets;
conductor and participant interfaces configured in the respective computer devices of said conductor and at least one participant for establishing a video session between said conductor and said at least one participant to interact with each other; and
a session module configured in the conductor computer device to select one of session plans and manage said video session for carrying out steps of the selected session plan, and to facilitate selection and retrieval of content of at least one of the session datasets stored being associated with at least one step of the selected session-plan.

2. (canceled)

3. The system of claim 1 wherein the conductor interface is configured to send to the computer device of the at least one participant instructions to request from the server the participant interface.

4. The system of claim 1 wherein each one of the plurality of session datasets comprises several sets of guiding data, each one of said several sets of guiding data being associated with a theme of a respective step or sub-step of the session-plan associated with the session dataset, and wherein the session plan is configured in a form of a concatenation of steps or sub-steps to be consecutively performed, or in a form of decision tree comprising a plurality of branches at least some of which connected by decision making junctions.

5. (canceled)

6. The system of claim 1 comprising a topic navigation component in the conductor and/or participant infaces configured for selecting one or more predefined topics and/or sub-step in each one of the steps of the selected session plan.

7. The system of claim 1 wherein each one of the plurality of session plans is configured to carry out at least one of the following: convey certain information or content, promote a certain agenda, achieve a certain task, facilitate a certain interaction process, utilizing the content selected for display in the participant interface.

8. The system of claim 1 comprising a participant analysis module configured to carry out one or more of the following: monitor communication from the at least one participant interface and determine a level of participation thereof; analyse participant's utterance, verbal intonations, and/or body language gesture; analyse communication from the conductor interface and present corresponding tips and/or recommendations to said conductor; present at least one tip or recommendation associated with time intervals associated with certain steps or sub-steps, or information or content items, of the selected session plan.

9. (canceled)

10. (canceled)

11. (canceled)

12. The system of claim 1 comprising a guidance component in the conductor interface configured to carry out one or more of the following: provide guiding information for interaction with the at least one participant; present to the conductor information and/or content of the session dataset used with the selected session plan; and/or step and/or sub-step of the selected session plan; and/or tips at least partially associated with a time duration measured by a timer indicative of a conductor and participant interaction time duration.

13. (canceled)

14. (canceled)

15. The system of claim 1 comprising an alerts section configured to issue alerts in the conductor interface based at least partially on a determined level of participation of the at least one participant and/or a measured conductor-participant interaction time duration.

16. The system of claim 1 comprising a reminders section configured to present in the conductor interface reminders at least partially associated with the information and/or content of the session dataset used with the selected session plan in accordance with the step and/or sub-step of the selected session plan.

17. The system of a claim 1 comprising an artificial intelligence (AI) module configured to produce insights, and/or identify patterns, and/or discover relationships, based on a plurality of communication sessions conducted by the system.

18. (canceled)

19. The system of claim 17 configured to generate new session plans and/or adjust existing session plans based at least partially on the products of the AI module and/or match a suitable session plan to at least one conductor based at least partially on the products of the AI module.

20. (canceled)

21. (canceled)

22. The system of claim 1 comprising a database accessible at least by the server for storing one or more of the following: the repository with the plurality of session-plans and a respective plurality of session datasets associated with said plurality of session-plans; guiding notes data records storing guiding comments/tips to be presented in the conductor interface during steps and/or sub-steps of communication sessions; project data records storing project information characterizing the certain information and/or content, and/or agenda, and/or task/goal, and/or interaction process of a plurality of interpersonal communication session to be conducted using the plurality session plans; session summary report data records storing at least one of the following: indication of steps conducted during communication session, information and/or content items presented to the participant(s) in each conducted step and/or sub-step of the session plan, data concerning the interactions between conductor(s) and participant(s) during a communication session, time intervals required for each step and/or sub-step of a communication session, scores associated with conducted communication sessions and/or the conductor, records of entire or partial previously conducted communication sessions.

23. (canceled)

24. (canceled)

25. (canceled)

26. A conductor interface configured to establish a video session for interaction between a conductor's computer device using said conductor interface and at least one participant's computer device using a participant interface operated therein in accordance with a session-plan comprising a plurality of session steps each one of said plurality of session steps being associated with at least one session dataset said conductor interface comprising a session module configured to manage said video session for carrying out session steps of said plurality of session steps of said session-plan, and to facilitate manual or automatic selection and retrieval of at least one of the session datasets associated with said session-plan for display in said participant interface.

27. (canceled)

28. The conductor interface of claim 26 comprising at least one of the following: one or more timers configured to measure time durations associated with a certain topic, and/or step, and/or sub-step, and/or information and/or content item, of the session-plan; a tips display area configured to present one or more tips at least partially associated with the time durations measured by the one or more timers, and/or information and/or content of the session dataset used with the session plan, and/or step and/or sub-step of the session plan; a session content display area for presenting the information and/or content items associated with the session-plan; an alert display area configured to display alerts based at least partially on a level of participation determined based on data communication from the at least one participant interface; a reminder display area configured to present reminders at least partially associated with the information and/or content used with the session plan in accordance with a step and/or sub-step thereof.

29. (canceled)

30. (canceled)

31. (canceled)

32. (canceled)

33. (canceled)

34. A conductor computer device configured to operate the conductor interface according to claim 26, and to communicate data with a server and at least one participant computer device.

35. (canceled)

36. A participant interface configured to establish a video session for interaction between a participant's computer device using said participant interface and a conductor's computer device using the conductor interface of claim 26 operated therein in accordance with the session-plan comprising the plurality of session steps said participant interface configured to present in said participant's computer device information selected and retrieved via a session module of said conductor interface and associated with said selected session-plan.

37. (canceled)

38. A participant computer device configured to to operate the participant interface according to claim 36, and communicate data with a server and the conductor's computer device.

39. A method of managing a video session between at least one conductor computer and at least one participant computer, the method comprising:
operating in said conductor computer a conductor interface configured to use a session plan for guiding said video session to follow a plurality of session steps, each one of said plurality of session steps associated with at least one session dataset associated with said session step;
carrying out in said conductor interface session steps of said plurality of session steps of said session-plan, for facilitating selection and retrieval of information and/or content items and/or perform instructions of at least one of the session datasets associated with said session-plan for display in said participant interface;
operating in said participant computer a participant interface configured to communicate data with the conductor interface operated in said conductor computer; and
receiving in said participant computer the information and/or content items selected via the conductor interface and presenting them in said participant interface.

40. The method of claim 39 comprising at least one of the following: using the conductor interface to select the session plan from a plurality of session plans; using the conductor interface to send session initiation data to said participant computer, said session initiation data configured to cause said participant computer to request the participant interface from a server, conducting steps of the session plan and presenting in the conductor interface specific information and/or content items associated with the step being conducted; presenting in the conductor interface tips and/or reminders and/or alerts associated with the conducted communication session; processing and analysing communication from the participant interface to determine a level of participation and generating the tips and/or the reminder and/or the alerts at least partially based on the determined level of participation, analysing communication from the conductor interface to determine one or more session progress parameters and generating the tips at least partially based on the determined one or more session progress parameters; analysing previously conducted interpersonal communication session and updating at least one of the plurality of session plans and/or information and/or content items associated therewith accordingly.

41. (canceled)

42. (canceled)

43. (canceled)

44. (canceled)

45. (canceled)

46. (canceled)

47. The method of any one of claim 39 comprising one or more of the following: receiving via the conductor interface instructions to move the session plan to a previously conducted step or sub-step, or to another step sub-step not yet conducted in the conductor interface; presenting in the conductor interface information and/or content items associated with an objecting received from the participant interface, permitting transmission of the conductor interface to the conductor computer upon successfully performing an authenticating step; using the conductor interface to send to the participant interface at least one of the following: and offer for sale, a price proposal, legal documents, or documents for signature; monitoring in real-time and presenting in the conductor's computer insights associated with at least one of the following: rate of speech of a participant, distribution of speech between the conductor and at least one participant, sentiment of terminology used in the communication session; transcribing at least some of the communication session in accordance with the steps of the selected meeting plan, carrying out voice recognition in real-time during the communication session; analyzing by an AI model recognized speech of at least one of the participants; monitoring in the recognized speech at least one of the following: specific terminology and/or expression, speech distribution, speech rate, body language, and/or relevant metrics.

48. (canceled)

49. (canceled)

50. (canceled)
